(19) United States
(12) Patent Application Publication
(10) Pub. No.: US 2002/0010736 A1
(43) Pub. Date: Jan. 24, 2002

(54) Internet based audio and video communication system using a virtual desktop

(75) Inventors: Hiran Josvel Marques, Miami, FL (US); Jaques Paves, Miami, FL (US); Scott Jeremy Engel, Miami, FL (US); Roberto Tom Price, Miami, FL (US)

Correspondence Address: OSTROLENK FABER GERB & SOFFEN, 1180 AVENUE OF THE AMERICAS, NEW YORK, NY, 100368403

(73) Assignee: TeleNova Communications Corp.

(21) Appl. No.: 09/799,959

(22) Filed: Mar. 6, 2001

Related U.S. Application Data
(60) Provisional application No. 60/187,288, filed on Mar. 6, 2000.

(51) Int. Cl. G06F 15/16

(52) U.S. Cl. 709/201

(57) ABSTRACT

An Internet-based computing and communications system includes a virtual desktop computer facility that resides on the Internet and is thereby available to its users at any time and from any location. The virtual desktop computer includes a suite of fully integrated web-based messaging, collaboration and personal information management applications. That system operates in conjunction with a buffer facility that can initiate simultaneous calls via multiple gateways anywhere on the Internet and which can, in turn, call regular telephone numbers as instructed over the Internet by users. An adaptive buffering technique reduces time delays and data-packet transmission over the Internet.

### RELATED APPLICATION

This Application claims priority and is entitled to the filing date of U.S. Provisional Application Serial No. 60/187,288 filed Mar. 6, 2000, and entitled “INTERNET BASED AUDIO AND VIDEO COMMUNICATION SYSTEM USING A PC.” The contents of the provisional patent application are incorporated by reference herein. This application is furthermore a continuation-in-part of the above-identified application.

### BACKGROUND AND SUMMARY OF THE INVENTION

The present invention generally relates to an Internet based communication system and, more particularly, to a PC controlled and Internet based audio and video communications system.

As herein defined, Internet telephony is a long-distance voice communications application using the public Internet. The enabling technology is a packet-switched data network based on the Internet Protocol (“IP”).

TeleNova implements Internet telephony services through a network consisting of gateways that interface between the public-switched telephone network and the Internet. The gateways receive the incoming call over the public telephone network, digitize and compress the voice transmissions into electronic data packets. The voice call assembled in packets is sent over the Internet to a destination gateway, which converts the call back to traditional analog format and sends it to the public telephone network for call termination. Regular phones are used, allowing phone-to-phone calls over the Internet.

Other features and advantages of the present invention will become apparent from the following description of the invention which refers to the accompanying drawings.

### BRIEF DESCRIPTION OF THE DRAWING

FIG. 1 is a general block diagram of the invention.

FIG. 2 is a block diagram showing the network architecture of the invention.

FIG. 3 is a block diagram showing the operations of a voice-enabled virtual desktop in accordance with the present invention.

FIG. 4 is a block diagram showing the operations of the interface of the voice-enabled virtual desktop of the present invention.

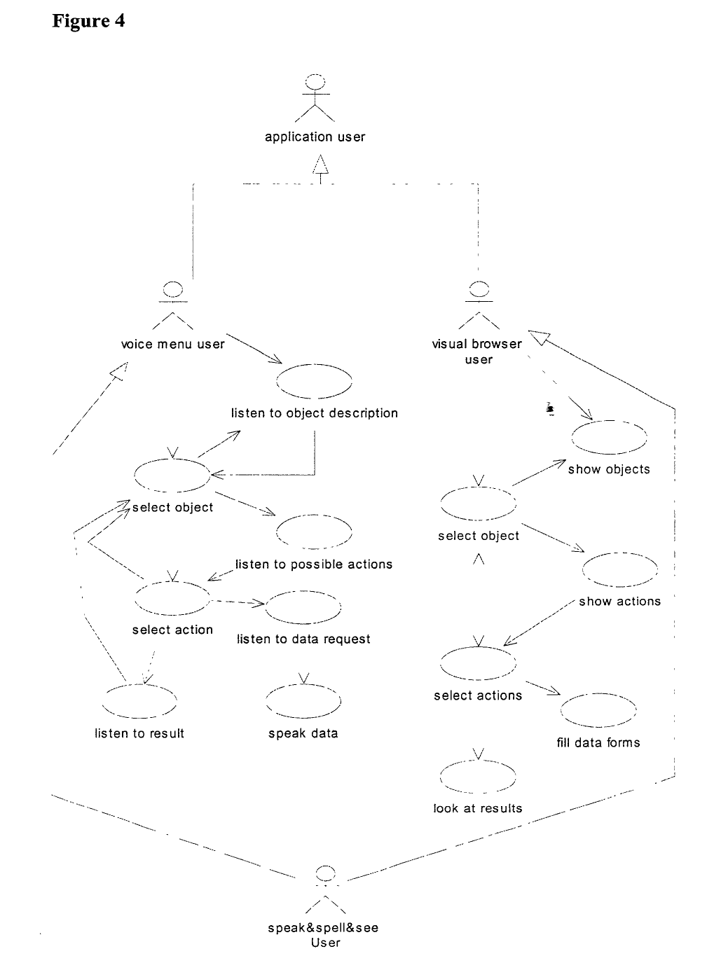

FIG. 5 is a block diagram showing the macro-component architecture of the voice-enabled virtual desktop of the present invention.

### DETAILED DESCRIPTION OF THE INVENTION

Electronic “traffic controllers,” called gatekeepers, control TeleNova.net. Gatekeepers help direct the traffic from an origination gateway to a termination gateway using the most convenient, and often less congested, route. Gatekeepers for TeleNova.net often reside in Network Operations Center (NOC).

For PC-to-phone Internet telephony, the PC replaces a desktop telephone. This represents an important application as Internet users increasingly use their PC to automatically dial from an address book and other hands-free communications. To complete a PC call to a traditional telephone and the PSTN, a gateway is required at the destination of the call. This is not required for PC-to-PC calls, where each PC acts as the gateway able to communicate with one another through IP.

In parallel to telephony via the Internet, another class of technology is emerging: the Web-based virtual computer. As broadband “always on” connections to the Internet become more pervasive and new types of access devices are created, it becomes feasible, and even desirable, to have the desktop move from the PC into the Internet.

TeleNova has in its portfolio such a product. MagicalDesk is a suite of fully integrated Web-based messaging, collaboration and personal information management applications combined in a “virtual desktop.” It is designed to improve personal productivity in data and file management, e-mail communication, and collaboration with a set of Internet software tools. It enables users to access their personal and shared information anytime, anywhere, from any device that supports an Internet browser, increasing the productivity of mobile professionals and virtual communities. The product integrates e-mail, calendar, address book, task list and bookmarks, allowing Internet users to share files, calendars, task lists and bookmarks with other users.

The MagicalDesk virtual desktop best exemplifies the advantages provides by the emerging application service provider (ASP) market: a suite of personal information management and collaboration tools, available to users anytime, anywhere through the Internet, eliminating the need to install and maintain expensive computer hardware and software.

By combining the technologies of Internet telephony and virtual computers, TeleNova created a novel architecture for Internet telephony network operation: the Web-based buffer for inter-gateway communication.

The virtual desktop with the buffer function, named NovaKeeper, can initiate simultaneous calls in multiple gateways anywhere on the Internet, which in turn will call regular telephone numbers as instructed over the Internet by NovaKeeper. All completed calls communicate with the buffer, which has a IP address and effectively acts as an originating gateway. NovaKeeper then relays the packets to their destination gateways, establishing the communication.

In addition to establishing end-to-end gateway communication, NovaKeeper's new and revolutionary algorithms perform concurrent functions such as packet synchronization, packet prioritization, cross-vendor gateway compatibility and adaptive network delay and jitter control. It also allows Internet telephony broadcasting with simultaneous browsing of Web sites over the same Internet connection.

Helping control and manage Internet delays is a major accomplishment, for they can be large and unpredictable. New technologies are becoming available in order to allow predicting delays between gateways arbitrarily connected to each other over the worldwide Web. When transporting voice over the Internet, there is limited information about, and little control over, the path the voice packets might take between any two gateways. There may be long delays, high packet loss and variable jitter; there may be good performance; or the performance may change over time. NovaKeeper introduces an adaptive buffering technique to reduce this problem for Internet telephony applications.

The above invention is implemented via an Internet-based control and synchronization software, enhancing some of the gatekeeping functions available today in standalone servers.

TeleNova's invention allows the Company to add voice-enabled features to the Web computer, creating a new voice-enabled virtual desktop with the following features:

NovaClick

NovaClick users are able to select a contact in their Web-based address book and the Internet telephony function of the virtual desktop will dial that person automatically.

eConference

Users are able to set up a conference call by selecting several contacts in their Web-based address book, setting a time and providing a telephone number to where the call should be sent. At the established time, the software will automatically call all participants and connect the call to the selected phone number. It may also be used to send e-mails to the participants with details of the scheduled call and automatically include the call in all participants' calendar and task list. Information files relevant to the call may be shared and simultaneously viewed remotely by all participants using the virtual desktop while one or more persons talk about it concurrently over the Internet using only one connection per person for voice and data.

eAssistant

Using unified messaging technology, TeleNova allows users to have access to their voice-mail and e-mail messages through the virtual desktop. If the user wants to return any of the calls received, he or she highlights the messages to be returned and the software will use the address book to automatically make a return phone call. The return calls may be made immediately or scheduled for a future time, with an item included in the task list. The calls may use any regular phone; the user informs the virtual gatekeeper of the most convenient telephone number, the sequence in which the calls should be made and the time interval between each call, and eAssistant will make the calls and put them through to the selected telephone.

This combination of TeleNova's Internet telephone technology and virtual desktop software in an integrated Web-based platform represents a technological innovation that brings numerous future business opportunities and exemplifies the paradigm shift of allowing Internet users to “work” the Web rather than just browse the Web.

TeleNova is able to deliver cost-effective Internet telephony service through technology that transmits telephone calls and faxes using IP over the Internet. Internet telephony provides less expensive long-distance and international audio communications because of the greater efficiency of the technology compared to traditional telecommunications networks. Traditional telecommunications networks using the so-called circuit-switching technology were conceived over a century ago, primarily for carrying voice. However, growth in the telecommunications industry is currently being fueled by data transmission. IP technology uses network infrastructure much more efficiently and allows for the transmission of voice and data simultaneously over the same network, creating dramatic cost reductions and opening the way for the development of new applications. IP-based networks are scalable and can be deployed at a fraction of the cost of the traditional networks.

Internet telephony is implemented through networks consisting of gateways that interface between the public-switched telephone networks and the Internet. Gateways receive incoming calls over public telephone networks and digitize and compress the voice transmissions into electronic data packets. These digitized data packets are then sent over the Internet to a destination gateway, which converts the call to its original analog format and sends it to the public telephone network for call termination. Additionally, the cost of voice and facsimile transmissions over the Internet is not determined by the distance those communications travel.

A Miami-based Network Operations Center (NOC) monitors the operations and provides near real-time, real-traffic network management information. In addition, the NOC houses the main gatekeepers, which help the function of routing packets from the origination gateway to the termination gateway. A second, smaller NOC for redundancy purposes is located in Sao Paulo.

All network elements are monitored 24 hours per day, seven days per week, and alarms are activated when a failure is detected. Performance and availability data are constantly updated allowing for exception handling, including re-routing to private IP networks and alternate use of the PSTN, if necessary. Stability and availability of gateways, gatekeepers and routers, quality of the Internet and PSTN links, and call detail records analysis in order to assess the call-completion rate are all functions performed by the TeleNova NOC. A sufficient number of NOC engineers are always on duty to promptly restore service, and minimizing, as much as possible, network down time. Notification of NOC personnel is accomplished via alarms, pagers, cellular phones and e-mail.

The Company's IP network currently has 12 points-of-presence (gateways) through which calls can be originated or terminated. The network footprint coverage encompasses several major cities in South America and nationwide coverage in the U.S. The Company expects to increase its footprint to over 40 cities throughout the Americas over the next 18 months. TeleNova's network supports Lucent Technologies and Cisco Systems gateways. The Company's network deployment program is designed to cover the major cities in the region.

In addition to TeleNova.net, the Company is building Web farms that will house the processing power, storage and supporting infrastructure to support the MagicalDesk platforms. The Web farms also serve as the technology platforms of enhanced services, integrating Internet telephony capabilities with the Internet-resident MagicalDesk product, as well as future Internet-based communication service applications to be developed by the Company.

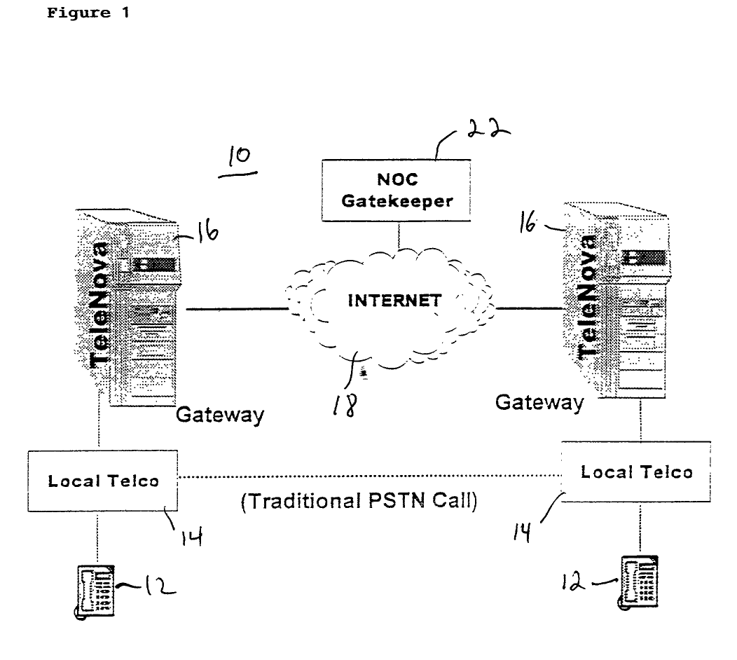

With reference to FIG. 1, the overall arrangement of the invention is such that it allows telephone or PC users of telephones 12 to communicate via local telephone companies 14 to reach their virtual computers which are symbolically indicated by reference numeral 16, which computers operate and communicate with one another via the Internet 18. This produces an overall system 10 that provides a virtual desktop computer facility with all the features thereof and includes a buffering function that is located in a NOC gatekeeper 22 that speeds up, synchronizes, and harmonizes data-packets switching to attain a fully-integrated multimedia communication and computing system.

### DETAILED DESCRIPTION OF THE NOVADESK VOICE-ENABLED VIRTUAL DESKTOP

1. Introduction

This portion describes an architectural implementation of a network-centric computing function, a voice-enabled virtual desktop, which allows users to access it from both the public Internet and the public switched telephone network. Hence, it effectively bridges the new packet switching Internet world and the more traditional circuit switching telephony world. Users can access their Internet-based computers anywhere, anytime, from any device.

The voice-enabled virtual desktop allows two types of users, a web browser user and a telephone device user, and may receive and process commands, messages and calls in text, HTML and voice formats. The system enables storage of messages and user data as address books, files in several formats and unlimited access through the Internet in voice and HTML interaction formats and through PSTN telephones in voice and touch-tones commands.

2. The web user standard virtual desktop functions

The web-user accesses the basic function of a desktop via a standard browser that has navigational and content exhibition in HTML or other formats or protocols. Some functions are downloaded to the personal computer and executed as applets and some functions are executed as servlets at the virtual desktop servers, making access to database, computer telephony and application components.

The functions available to the web user are to create, update and access data entries in stored data files as address books, bookmarks, personal files of various forms, task lists, stored greeting and other types of messages, received and sent e-mail and other forms of messages. There are a number of alternative implementations available in the market for the virtual, Web-based desktop functionality, and this invention uses one, called MagicalDesk. Refer to the table below for a summary of the MagicalDesk functions.

TABLE

| Description | Benefits |
|---|---|
| Free email account | Consolidates multiple email accounts |
| Web-based calendar and | Users can maintain private or shared |
| address book | calendars for collaboration and/or |
| Accessible through email | setting meetings |
| | Centralizes users' contact |
| | information in one place, available |
| | from any Internet connection |
| Web-based task list/To Do list | Users can convert an email or |
| Synchronizes with PDAs | calendar event into a personal task |
| | item |
| Web addresses are bookmarked | Allows users easy access to their |
| within MagicalDesk | personal bookmarks or favorites from |
| | any Internet connection |
| Web-based storage of computer | Creates a virtual network accessible |
| files | among multiple users |
| Private and public folders | |
| available | |
| Files are stored on a secure | |
| server environment | |
| Software that converts files | Allows files to be viewed, |
| created in over 250 different | manipulated and integrated into other |
| applications to be viewed, | files even if the host computer does |
| manipulated and integrated into | not have the applications used to |
| other files | create the file |
| Downloadable software | Ensures that users have the most |
| application which can | current copy of their files from |
| synchronize files and bookmarks | wherever they are working |
| automatically | |
| Synchronizes with PDAs such as | |
| Palm and Windows CE machines | |

In the standard mode the web user browses the desktop pages, clicking on menu buttons and other forms of interactive communication to have commands issued to the system. And the system responds by issuing messages, opening pages with forms to be filled by the user and showing the contents of the associated database entries.

3. The web user voice communication

The web user has also available functions to send audio messages, place phone calls, program phone calls or audio messages to be scheduled in the tasks, select phone numbers to place calls from the address book, and other related voice transmitting operations. These functions make use of a number of software packages that enable compression and encoding of voice (codecs), protocols to transmit voice over communication networks, and require a PC enabled with audio reproducing and microphones at the user client side. The voice is transmitted over the Internet making use of a network of hardware and software, as described in the background section. The calls are routed to the PSTN telephone through the gateways, making sure the quality of the call is acceptable to the users.

To place a call the user selects this option from the menu, which causes an applet to be downloaded. This in turn asks for the user to select the contact and telephone field in the address book, or to type directly the country and area code and telephone number of the destination in a proper field. Upon pressing the place-a-call button the PC-to-phone procedures are activated to negotiate a call through the network. When the other party answers the call the user will hear it and can then start the conversation. If the call is unanswered the user can cancel the connection and try again for the same number or change the called number. Alternatively the user can use the click-to-talk option, clicking directly on a selected phone number in the address book, that will activate the same PC-to-phone procedures. The user can also create special icons on the virtual desktop that will enable the placing of calls to a specific number associated to the icon whenever the button is activated.

The voice enabled virtual desktop also has a workflow engine that allows the programming of calls within its tasks. Users may request the Voice Enabled Virtual Desktop to activate calls for them at pre-programmed times (as the last day of the month, at noon), to selected addresses of the address book. When the date occurs a call is placed from the user personal computer, if he is logged in, otherwise a voice message is sent by e-mail or phone call to the user's set-up choice, informing her that she missed the programmed call. This invention makes use of a workflow engine.

To program a call to occur, the user selects a command page, filling in the details to be followed. These include the date and time of the calls, number of rings before failure, number of attempts if phone called is engaged, or alternative phone numbers, or message to be left. The date can be set as one unique call, or recurring calls, on every day, on every given week days, on every given month-days (for example 1^{st} day of every month, 5^{th} day, last day, last day-3, etc.).

The address book functions to allow a number of formats of address books to be accessed, thus enabling the user to import data from several other address books into the virtual desktop address book. The user is saved a lot of work if she had to manually synchronize all her diverse address books of several tools. This virtual-desktop address-book has several specific entries, storing numbers and addresses as fax, cellular phone, standard telephone, e-mail address, IP address, etc.

Instead of placing a call, an audio message can be sent, either in scheduled fashion or at user will. The audio message can be prepared in advance by the user recording voice or preparing audio or by functions that synthesize speech from text. These functions require a number of components such as speech synthesizers in many languages, and also text translators from several languages, as well as audio and sound software at the client personal computer.

Making use of these components a number of additional functions for the web user are made available to enable the automatic handling of messages according to the destinations they are sent to. Messages can be in voice, audio, text or HTML formats. The address book has entries for addresses classifying them as fax, phone, IP-address or email-address. Therefore the user can send or forward a message of any type to an address of any type. Messages sent to fax machines are transformed from HTML and voice formats into text, messages sent to phones are synthesized into voice from text formats.

4. The web user voice-enabled interaction

A user may also scan the messages in his or her preferred format. For instance he or she may want to hear to the unread messages in the background while preparing a text on the personal computer.

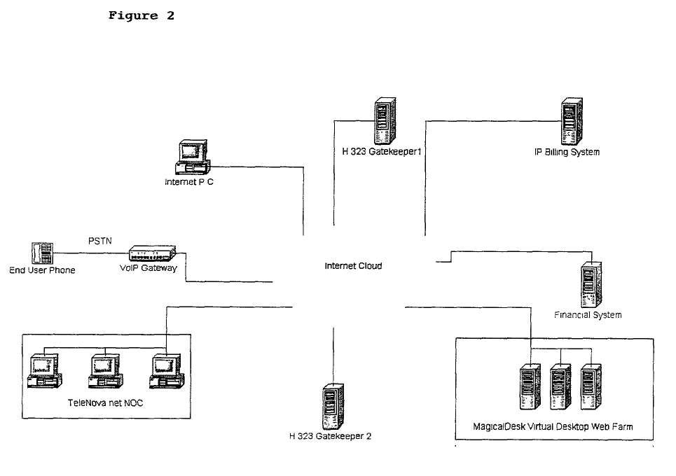

The web user, as the telephone device user (as will be seen further down), can also interact with the invention through voice. For this purpose speech recognition systems are deployed, associating to each menu entry or command icon also a list of synonyms in text and recorded voice, therefore enabling a search mechanism to look-up the table of commands for voice or text equivalents. The interaction system using voice recognition recognizes the voice stream, represents the recognized words as text, and looks up the commands according to the context of the user navigation on the web pages of the Voice Enabled Virtual Desktop. The voice-enabled virtual desktop is unified with an Internet-based IP telephony network such as provided at TeleNova.net. See FIG. 2.

5. The telephone device user

The Voice Enabled Virtual Desktop is also reachable through telephone devices for voice interaction with a user not connected to the Internet, thus allowing far more user mobility. The telephone device user accesses the Voice Enabled Virtual Desktop by placing a call to the computer telephony media server that handles the incoming calls and provides the bridge between the Internet world and the telephony world. This media server resides on a cluster of servers associated to the database server and web server, forming a Web farm and allowing for IVR and other call processing functions to check the user identity, authorization and authenticity.

All virtual desktop functions are available for the telephone device user. The main functions a telephone device user will effectively activate probably deal with processing messages and placing calls, but he may activate all the voice-enabled virtual desktop functions.

The telephone device user may select what message folder he or she wants to hear, may ask for message headers to be read one by one, until a particular message is selected. Afterwards this message can be repeatedly requested to be read, to be forwarded (to addresses to be selected from the address book), to be answered, to place a call to the sender on phone or IP-address, or to be discarded. Other typical functions a telephone device user can request is to place calls, examine the address book searching for registered contacts, add entries to an address-book, create messages to send to a number of users, schedule calls and tasks, ask for messages to be forwarded to follow-me-addresses, update the tasks and to-do-lists, participate in workgroups, etc.

After a telephone user is connected to the invention he or she is invited to inform his or her preferred way of interaction, either through menus, in touch-tones or spoken words, or through speech commands. If the user selected the menu option, he is then presented with a succession of hierarchical options, equivalent to the web interface. If the user selected speech commands he or she is invited to utter simple phrases that have a verb and object identification.

In the menu-following option the user hears the synthesized voice listing all the options of the menus. The first menu is about all the macro features of the virtual-desk-top, as address-book, message-folders, bookmarks, stored files, place-calls, etc. If the user selected touch-tone, a spoken number accompanies every spoken menu entry. The user selects one of the options, either by touch-tone or by speaking back the option keyword. Then the next menu options are spoken to the user, who selects the desired choice. When the main menu selection is finished, the user will be invited to enter a number of data entries. For instance, if the user selected “create a new address book” entry, he will be invited to submit the contact name, in spelled form, then the type of address (fax, telephone, e-mail, etc), followed by the sequence of digits or letters. If the user requested a “place a call” option she will be invited to submit a contact name, or failing to do that she will be requested for a telephone number (digit by digit).

With speech command the verb is associated to one of the actions of the invention—as place a call, read messages, create address book entry. The object identification, as the name of a contact—for placing a call, or the name of the folder—for reading its messages, has to associate a proper object to that action verb.

6. Receiving messages

A user of the voice-enabled virtual desktop has several means of receiving messages and accessing messages, as E-mail, phone calls, fax messages. E-mail messages using POP3 are synchronized from several e-mail servers into the virtual desktop and stored in the received-messages folder. These messages can be in text, voice mail or HTML. The user has a page to fill-in details to the servers to synchronize the filtering of the messages and other automatic processing features.

Every user of the Voice Enabled Virtual Desktop can also receive phone calls. There are several ways of placing calls to a user. An 800 toll free number can be used, or each user receives a unique PSTN number, or a user is assigned a unique global operator number. With the 800 solution the computer telephony media server processes the calls and accepts an user identification typed in as touch tones (either a code or a name by which the user is known to the outside callers and to the Voice Enabled Virtual Desktop) or spoken to. With the unique PSTN number, each server of the system has to be associated to a collection of PSTN numbers, one per user, and calls to a user are always placed to this telephone number. The user can also program her/his telephone with her/his operator to forward calls to the virtual-desktop when she/he does not wish to receive directly her/his calls. In this case the invention receives the forwarded call and identifies the sender as a user (by the sender country and area code and telephone number) and processes the call accordingly. With a network of gateways on pops covering a wide area, there might be several pops hosting servers that can receive calls and route these calls to the virtual-desktop server to be processed. Please refer to an example of such a network, TeleNova.net, in FIG. 2.

The calls and messages sent to a user are filtered as they are being received and either stored for further access or re-routed for immediate attention. For example, phone calls can be immediately forwarded to a given PSTN telephone number or IP-address, can be stored and a copy forwarded to voice-compatible addresses, or stored and transformed into text and forwarded to text-compatible addresses. A number of functions are available for input calls forwarding or processing, and specified in a proper form.

The voice enabled virtual desk-top can be used for communities of users that share common interests, or work together, therefore a robot for capturing and placing messages of interest to the members of the community, as weather forecasts, stock markets, traffic conditions, technology news or whatever knits them together can be deployed. Users can access those messages anywhere, anytime, from any device, as they please.

The Voice Enabled Virtual Desktop is an invention that is built of several servers, networks and clients. What characterizes the invention is the integration of all those components into a fully unified service of centralized storage of computer applications, messages and data with access and communication over the Internet and from public telephony networks with voice-enabled commands.

7. Uses of the Voice-Enabled Virtual Desktop

Important uses of the invention are:

Communication between mobile and distributed users,

Sharing of Information,

Organization and centralization of data,

Voice enabled access in background for busy or handicapped users,

Access to data and messages directly via telephone connections,

Placing and Scheduling of telephone calls.

a. Communication between mobile and distributed users

The Voice Enabled Virtual Desktop is accessible through the Internet and through the telephone network, therefore mobile users can access it even if they are not connected to the Internet, as for instance from hotel rooms in foreign countries where they do not have Internet access providers. Mobile users can communicate with the base office by sharing information stored in the Voice Enabled Virtual Desktop as well as through messages and recorded voice mail and phone calls.

b. Sharing of Information

The Voice Enabled Virtual Desktop can contain data and messages that are of interests to working-groups, that so can share this data in a common repository, accessing it remotely and updating and sharing a schedule of tasks to be done on this data.

c. Organization and centralization of data

The virtual-desk-top allows users to classify data in several folders, store and visualize data in several formats, thus enabling a better sharing and housekeeping.

d. Voice enabled access in background for busy or handicapped users

With the voice enabling function available for the web user, he can perform other tasks, as editing texts or examining visual data as tables or diagrams, while still in the background being able to process his messages.

e. Access to data and messages directly via telephone connections

With the telephone processing facilities the Voice Enabled Virtual Desktop offers very handy service for mobile users, as they can hear through normal telephone calls their e-mail messages and received voice messages, and also interact with the invention to send e-mails, forward messages etc.

f. Placing and Scheduling of telephone calls

By using the network of gateways and gatekeepers users of the invention can place calls to standard PSTN telephones through the Internet, and schedule calls to occur at pre-established times.

g. Virtual workplace for collaborating workgroups

Users may share data, address-books, documents and the communication facilities that the voice enabled voice virtual desktop offers, effectively promoting the integration of distributed and mobile users.

h. Unification of internet-based computing and communications

A distinctive feature of the invention is this ability to bridge into a unique web based repository of applications for data in diverse formats and messages in diverse means, the Internet and the public telephony network.

8. Advantages of the Voice-Enabled Virtual Desktop

Further important advantages of the invention are:

i. Reduced communication costs,

ii. Friendlier user interaction through voice enabling,

iii. Unified messaging system with a virtual desktop,

iv. Integration of distributed and mobile groups

a. Reduced communication costs

There are a number of ways the invention contributes to the reduction of communication costs:

By reducing the needs of communication, between home and mobile and distributed users, because data is shared on a central repository among a group of distributed and mobile users. Instead of having to communicate to every member of the group the actual changes in shared data, the users are communicated via e-mail that a change has occurred and those interested in it access the virtual desk top. The number of calls and volume of data is reduced.

By reducing the direct cost of each telephone bill, because the network supporting the voice communication uses the Internet thus providing a substantial cost reduction per minute of conversation, mainly if international calls are involved.

By eliminating many long calls, as the invention provides storing facilities for voice and other messages, and forwarding of voice mail through the Internet.

By reducing the number of communications required.

As the invention has a number of facilities for call screening when they are received, storing messages, forwarding calls, and even attending call requests, a number of reply or follow-up calls may be eliminated, thus reducing the overall phone bill of the community using the invention.

b. Universal and friendlier user interaction through voice enabling

The users can interact with the invention through voice via phone calls or when browsing the pages, enabling background handling of messages while performing other tasks.

c. Unified messaging system with a virtual desktop

The invention receives, processes and stores messages and calls coming in from telephones, voice communication over the Internet, faxes, and e-mails. These messages become integrated with the voice-enabled virtual desktop functions and are treated as uniformly as possible, being able to be forwarded, read, heard and manipulated in several ways, being submitted to changes in format as required for the receiving media.

d. Integration of distributed and mobile groups

As several users may share data, address books, messages, and a friendly and low cost environment for communication among communities, this increases the integration of the members of the group, thus enabling better productivity and common goals to be achieved.

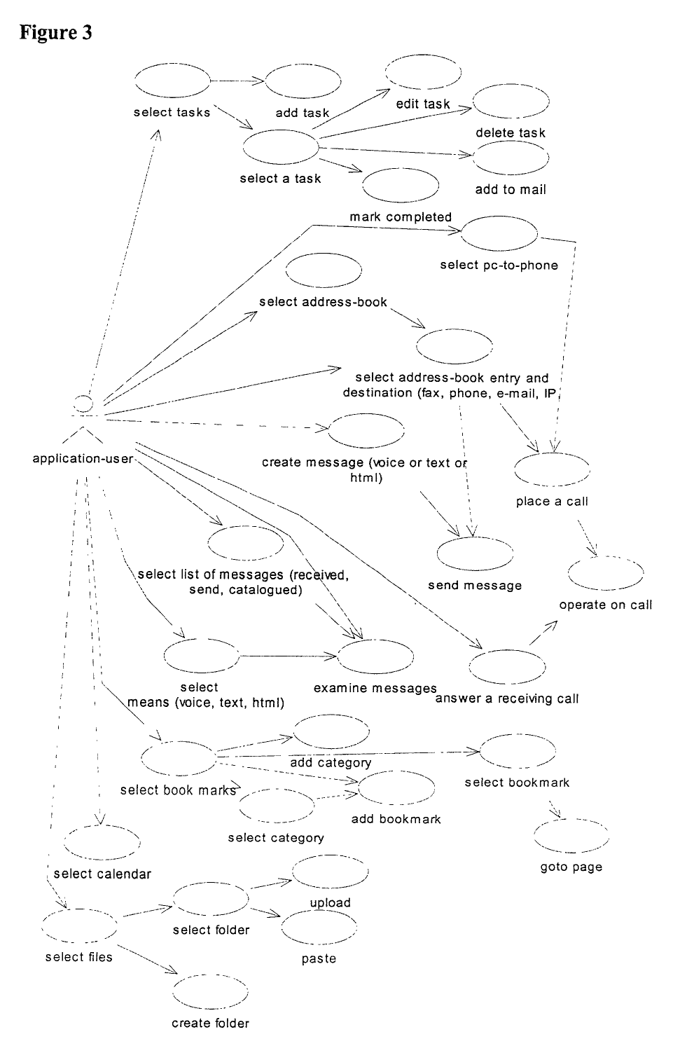

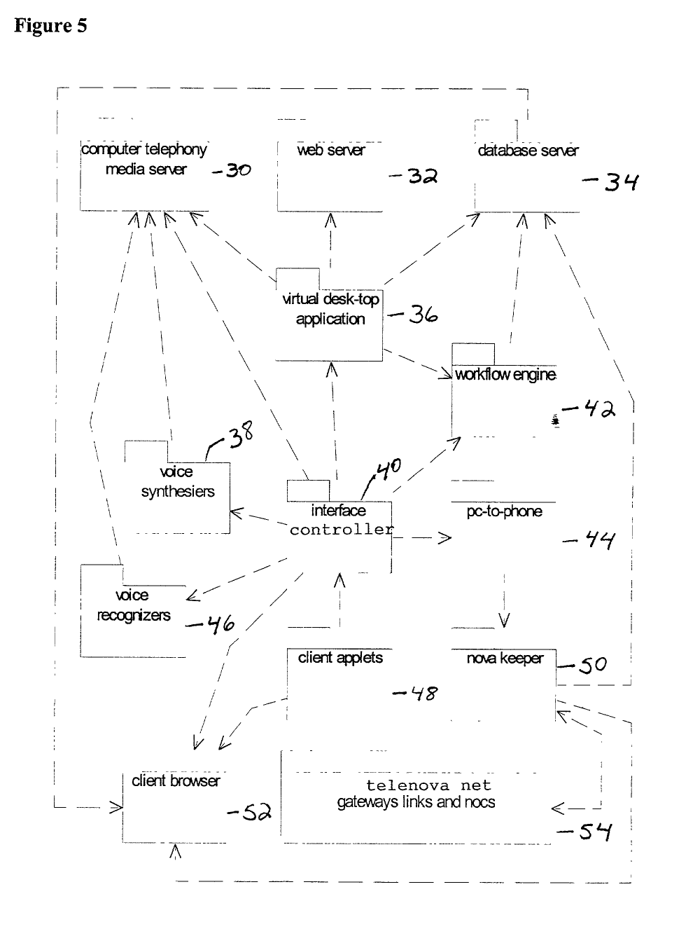

The figures are self-explanatory. FIGS. 1 and 2 show major components of the layout of the system. FIG. 3 shows in block diagram format an application user interacting with the system which provides the various functionalities that are listed in FIG. 3. A similar diagramatic layout and flow table is provided for an application user using the voice-enabled functionality that allows users to avail themselves of the various functionalities via a speak/spell/see mode of operation. FIG. 5 shows key hardware/software constituents of the invention which includes the interface comptroller 40 that interacts with the virtual desktop application 36, the workflow engine 42, the pc-to-phone facility 44, client browser 52, the voice recognizers 46 and the voice synthesizers 38.

The interface controller 40 also interacts with the computer telephony media server 30. The aforementioned components in turn interact with one another as shown, as well as with the web server 32, the database server 34, the nova keeper 50, and the telenova net gateways links and nocs 54. The client applets component 48 interacts with the interface controller 40, as well as with the client browser 52. The various flow lines and text in the Figures are an integral part and constitute a portion of the overall disclosure of the invention.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An Internet-based system, comprising:
a virtual desktop facility, including a suite of personal information management and collaboration tools available to users thereof remotely through the Internet;
a communication buffer facility structured to initiate simultaneous calls in multiple gateways anywhere on the Internet, the virtual desktop facility communicating with the Internet via the buffer facility and the buffer facility having its Internet Protocol (IP) address and serving as an originating gateway for the virtual desktop facility; and
an adaptive and software based buffering system operable with the buffer facility that controls data packet messaging on the Internet in a manner that reduces time delays and controls and synchronizes data transmission.

2. The system of claim 1, in which the buffer facility communicates in packet-switched data network based on the Internet Protocol (IP).

3. The system of claim 1, in which the buffer facility operates as an Internet gatekeeper and the gatekeeper operates in a network operation center.

4. The system of claim 1, in which the system operates in a broadband mode so as to maintain an always on connection to the Internet.

5. The system of claim 1, further including a voice-enabled facility through which commands are directed to the virtual desktop facility.

6. The system of claim 5, further including a telephone facility for placing telephone calls via the virtual desktop facility, whereby telephone calls are routed and carried on via the Internet.

7. The system of claim 1, further including a facility that enables voice-activated calling of parties whose identities are listed in the virtual desktop facility.

8. The system of claim 1, further including a conferencing facility which selects several contacts from a web-based address book and establishes a conference call.

9. The system of claim 1, further including a voice-mail and e-mail messaging facility available through the virtual desktop facility.

10. The system of claim 1, including a network interface for establishing communication outside the American continent.

11. The system of claim 1, further including a plurality of Web farms that house processing power, and a storage and supporting infrastructure to effect software functions required by the system.
